(19) United States
(12) Patent Application Publication
(10) Pub. No.: US 2012/0256728 A1
(43) Pub. Date: Oct. 11, 2012

(54) HIERARCHICAL FAST COLLECTION PROCEDURE

(75) Inventors: Zeljko BAJIC, San Jose, CA (US); Nikola CARGONJA, San Carlos, CA (US); Albert NARDELLI, Mountain View, CA (US); Joseph S.M. HO, Sunnyvale, CA (US)

(73) Assignee: Savi Technology, Inc., Mountain View, CA (US)

(21) Appl. No.: 13/441,254

(22) Filed: Apr. 6, 2012

Related U.S. Application Data
(60) Provisional application No. 61/473,684, filed on Apr. 8, 2011.

(51) Int. Cl. G06K 7/01

(52) U.S. Cl. 340/10.1

(57) ABSTRACT

A system for collecting information from one or more radiofrequency identification (RFID) tags is provided. The system includes one or more RFID tags and a first interrogator device. The first interrogator device may be configured to perform interrogator functions in a first wireless network and perform tag functions in a second wireless network. The interrogator functions include transmitting a wake-up signal and a collection request command to the one or more RFID tags, and the tag functions include responding to a wake-up signal and transmitting a collect response message in response to a received collection request command. The system also includes a second interrogator device configured to perform interrogator functions in the second wireless network that include creating the second wireless network, transmitting a wake-up signal and a collection request command to the first interrogator when the first interrogator is in the second wireless network.

### RELATED APPLICATIONS

This application claims priority to U.S. Provisional Application No. 61/473,684, filed on Apr. 8, 2011, the entire contents of which are incorporated herein in their entirety.

### BACKGROUND

1. Technical Field

The embodiments described herein are related to wireless information collection. In particular, embodiments described herein describe systems and methods for the hierarchical information collection from radiofrequency devices, such as radiofrequency identification (RFID) tags, utilizing hybrid devices that may act as both an RFID tag and a radiofrequency interrogator.

2. Description of Related Art

In the field of radiofrequency tag networks, polling and collecting information, such as data, from a large number of fast moving tags is often necessary. In these situations, a group of fast moving tags passing through a chokepoint may be awakened by a wake-up signal generated by a signpost or interrogator. Thus, all tags compete to get time slots needed for exchange of messages containing relevant and requested information and data. As the population of tags become larger and speed of the moving tags increases, physical limits of the network such as the bit rate are becoming a limiting factor for performance. Many possible collisions and retransmissions drastically reduce the number of tags being collected in the short time available to transmit the information and data while in range of the signpost or interrogator.

What is needed is a system and method that reduces the number of collisions and retransmissions at chokepoints in radiofrequency tag networks.

### SUMMARY

Consistent with some embodiments, there is provided a system for collecting information from one or more radiofrequency identification (RFID) tags. The system includes the one or more RFID tags and a first interrogator device. The first interrogator device is configured to perform interrogator functions in a first wireless network, the interrogator functions including creating the first wireless network, transmitting a wake-up signal and a collection request command to the one or more RFID tags, and perform tag functions in a second wireless network, the tag functions including responding to a wake-up signal and transmitting a collect response message in response to a received collection request command. The system also includes a second interrogator device, the second interrogator device configured to perform interrogator functions in the second wireless network, the interrogator functions including creating the second wireless network, transmitting a wake-up signal and a collection request command to the first interrogator when the first interrogator is in the second wireless network.

Also consistent with some embodiments, there is provided a method for collecting information from one or more radiofrequency identification (RFID) tags by an interrogator. The method includes transmitting, by the interrogator, a wake-up signal, transmitting, by the interrogator, a collect request command, receiving, by the interrogator, a collect response message, and transmitting and receiving, by the interrogator, additional application requests.

Further consistent with some embodiments, there is provided a hybrid interrogator device. The hybrid interrogator device includes a power source, a processor, a memory coupled to the processor, a clock generator coupled to the processor, a beacon signal generator coupled to the processor, and a transceiver coupled to the processor. The memory includes instructions that, when executed by the processor cause the hybrid interrogator device to perform interrogator functions in a first wireless network and perform tag functions in a second wireless network.

These and other embodiments will be described in further detail below, with reference to the following drawings.

### BRIEF DESCRIPTION OF THE FIGURES

FIG. 1 illustrates a general RFID system according to some embodiments.

FIG. 2 illustrates a protocol stack that can be utilized in wireless communications, consistent with some embodiments.

FIG. 3 illustrates a packet format for wireless transmissions, consistent with some embodiments.

FIGS. 4A and 4B illustrate methods for polling a tag by an interrogator, consistent with some embodiments.

FIG. 5 is a diagram illustrating a wireless tag network on a moving platform, consistent with some embodiments.

FIG. 6 illustrates a wireless tag network in a higher hierarchical level, consistent with some embodiments.

FIG. 7 illustrates a system having multiple wireless networks in a hierarchical level, consistent with some embodiments.

FIG. 8 is a diagram illustrating a higher hierarchical level of the system shown in FIG. 7, consistent with some embodiments.

FIG. 9 is a diagram illustrating a higher hierarchical level of the systems shown in FIGS. 7 and 8, consistent with some embodiments.

### DETAILED DESCRIPTION OF THE FIGURES

This disclosure provides embodiments of systems and methods for operating a wireless network enabling collection of a large number of fast moving tags in a short period of time. A wireless network may include a plurality of tag devices communicating with at least one interrogator device through radio frequency signals. In some embodiments, the tag devices may also communicate with each other. The tags in the network may be mobile while the interrogator is fixed, according to some embodiments. In some embodiments, the interrogator may also be mobile. Furthermore, in some embodiments the wireless network may include a hybrid type interrogator device that acts as an interrogator in some instances and as a tag in other instances.

Consistent with some embodiments, data collection from the tags is performed hierarchically, at two (or possibly more) levels: first, all mobile tags are collected periodically by a hybrid device (an interrogator/tag), in this instance acting as an interrogator device. If the tag group passes through a chokepoint the hybrid interrogator device, in this instance behaving as a tag device, is queried by an interrogator at a second hierarchical level. Thus, the interrogator in the second level collects from a hybrid device data retrieved from a plurality of moving tags during the periodic collection procedure. In some embodiments, the periodic collection procedure at a first hierarchical level may include a beacon enabled wireless network.

The number of hybrid interrogator devices acting as tags in a higher hierarchical level is in general much less than the number of tags in a lower hierarchical level. In some situations, data from only one hybrid interrogator device may be collected. Thus, the number of collisions is minimized and the amount of data transferred in a short period of time in the higher level is maximized. In some embodiments beacon enabled wireless networks and beaconless wireless networks may be used to support the hierarchical collection method. Some embodiments may perform the methods disclosed herein with the International Standards Organization (ISO) 18000-7:2009 protocol type of networks at one or more of the hierarchical levels. In some embodiments, other wireless technologies and protocols can be used such as the Institute of Electrical and Electronic Engineers (IEEE) 802.15.4 protocol.

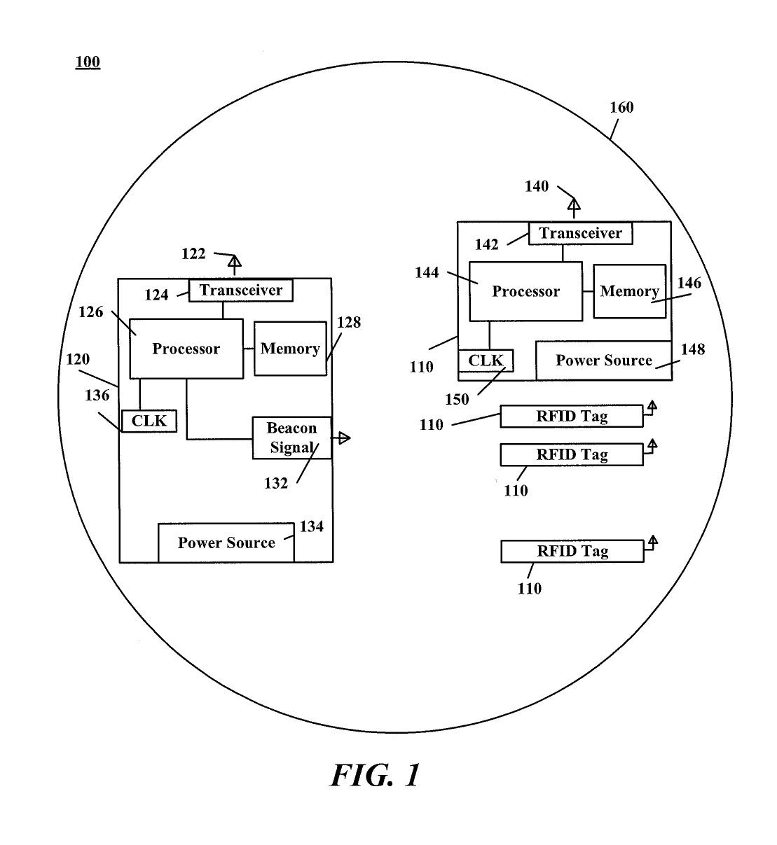

FIG. 1 illustrates a general RFID system 100 according to some embodiments. FIG. 1 illustrates an interrogator device 120 communicating wirelessly with a number of RFID tags 110. Any number of RFID tags 110 can be located in an area monitored by interrogator 120. Interrogator 120 communicates with one or more of RFID tags 110 wirelessly in order to read or write information, such as data, from the one or more RFID tags 110. Interrogator 120 includes a processor 126 that may be configured to execute instructions stored in memory 128 to, among other things, communicate with tags 110. Memory 128 may also store data and operating parameters, buffers, registers, and tables. Interrogator 120 includes a clock 136 that controls timing for interrogator 120. Processor 126 is coupled to a transceiver 124, which is coupled to an antenna 122, to wirelessly transmit and receive signals. Signals transmitted from antenna 122 may create a wireless network 160 having a range illustrated by the circle in FIG. 1 that tags 110 may be associated with in order to communicate information to interrogator 120 in response to queries from interrogator 120.

Interrogator 120 is powered by a power source 134. Power source 134 can, for example, be a battery or an external power source. Consistent with some embodiments, particularly as disclosed herein, interrogator 120 may be a hybrid interrogator having the capabilities of both an interrogator and a tag. Such hybrid interrogators may contain fully functional interrogator and tag devices such that each interrogator portion and tag portion may be fully configurable. Memory 128 may contain instructions that, when executed by processor 126, cause interrogator to perform interrogator functions in one wireless network and tag functions in another wireless network. Consistent with some embodiments, interrogator functions include creating a wireless network 160, transmitting a wake-up signal and a collection request command to RFID tags 110. Tag functions include responding to a wake-up signal and transmitting a collect response message in response to a received collection request command. Each portion of the hybrid interrogator may have its own unique media access control (MAC) address. A hybrid interrogator can be configured to behave as an interrogator in one network and a tag in another. Further, in some embodiments a hybrid interrogator can be configured as two interrogators or two tag devices, enabling support for additional uses.

RFID tag 110 includes a processor 144 coupled to a memory 146. Consistent with some embodiments, processor 144 may be configured to execute instructions stored in memory 146 to communicate with interrogator 120 or perform other tasks. Processor 144 is further coupled to transceiver 142, which is coupled to antenna 140, through which tag 110 can wirelessly communicate with interrogator 120. Tag 110 includes a clock 150 that provides timing for tag 110. Tags 110 also include a power source 148, which typically is a battery. In tags 110, however, power stored in power source 148 is conserved and conservation efforts are utilized to insure that tags 110 are continuously useful during their use.

In some embodiments, interrogator 120 may include a beacon signal generator 132 to periodically generate a beacon signal for tags 110. In some embodiments, system 100 is synchronized through clock 136. Clock 150 in tags 110 match signals received to the timing of clock 136. In such systems 100, beacon signal generator 132 may not be used and network 160 may be a beaconless network. Further, beacon signals generated by beacon signal generator 132 may include information regarding system 100, such as network capabilities provided by interrogator 120.

System 100 may include any number of tags 110 or interrogators 120. Tags 110, which are often attached to shipments, for example shipping containers, that are in transit between locations are read, or collected, as they come into range of an interrogator 120, which may be illustrated by network 160. Although specific examples of aspects of system 100 and of interrogators 120 and tags 110 are provided below, specific examples are provided only to facilitate better understanding of aspects of the present invention. It is to be understood that other arrangements than those specifically described can be implemented while remaining within the scope of this disclosure.

Typically, tags 110 are low power devices and spend much of their time in a sleep mode of operation. During normal operation, each of tags 110 wakes periodically to monitor for a wake-up signal from interrogator 120. The wake-up period can be set to be any interval that maximizes a desired wake-up time while minimizing power consumption. Alternatively, the wake-up period may be determined by a standard or protocol. In the 18000-7:2009 protocol, for example, tags 110 wake up once every 2.4 sec to check for a wake-up signal from interrogator 120. Upon wake-up, if tag 110 detects the wake-up signal, tags 110 remain awake to exchange further information with interrogator 120. If no wake-up signal is detected, then tags 110 return to a sleep mode.

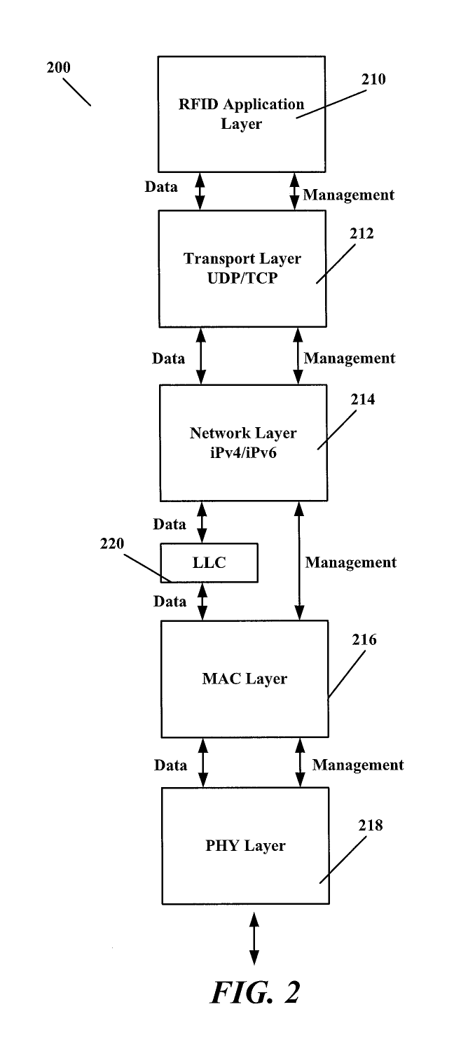

FIG. 2 illustrates a protocol stack 200 that can be utilized by interrogator 120 and tag 110 in communications, consistent with some embodiments. As shown in FIG. 2, protocol stack 200 includes multiple protocol layers 210-220. Each layer is responsible for one part of the protocol stack and offers services to the higher layers. The layout of the layers is based on the open systems interconnection (OSI) seven-layer model (see ISO/IEC 7498-1:1994), and the interfaces between the layers serve to define the logical links. The layers include the RFID Application layer 210, a transport layer 212, a network layer 214, a Media Access Control (MAC) layer 216, and a Physical (PHY) layer 218.

Consistent with some embodiments PHY layer 218, contains the radio frequency (RF) transceiver and receiver along with a low-level control mechanism. PHY layer 218 may provide a PHY data service and a PHY management service. A PHY data service enables the transmission and reception of PHY protocol data units across the physical radio channel. The features of PHY 218 include activation and deactivation of the radio transceiver, energy detection (ED) within the current channel, link quality indication (LQI) for received packets, clear channel assessment (CCA) for carrier sense multiple access with collision avoidance (CSMA-CA), channel frequency selection, and data transmission and reception. Consistent with some embodiments, PHY layer 218 is performed partly in processors and transceivers of interrogator 120 and tag 110.

Consistent with some embodiments, MAC layer 216 provides a MAC data service and a MAC management service. The MAC data service enables the transmission and reception of MAC protocol data units across the PHY data service. The features of MAC layer 216 include management of power saving devices, synchronization, channel access, frame validation, acknowledged frame delivery, network association, and network disassociation. In addition, MAC layer 216 may provide infrastructure for the MAC layer security. Consistent with some embodiments, MAC Layer 216 supports one or more of authentication, key derivation procedures, and crypto algorithms such as those defined in the ISO/IEC WD 29167-7. Consistent with some embodiments, the functions of MAC sub 216 are performed in the processors of interrogator 120 and tag 110.

Protocol stack 200 also includes a network layer 214 and a transport layer 212. Data may be received into MAC layer 216 from network layer 214, and may be coupled to a logical link control (LLC) 220 between network layer 214 and MAC layer 216. An IEEE 802.2 Type 1 logical link control (LLC) 220 can access the MAC layer through the service-specific convergence sub-layer (SSCS). Network layer 214 may also provide network configuration, manipulation, and message routing services to transport layer 212. The functions of network protocol layer 214 can include connection services, host addressing, and message forwarding. In some embodiments, network layer 214 can support, for example, IPv4 or IPv6 internet protocols. Other supported networking protocols include Distance Vector Multicast Routing Protocol (DVMRP), Internet Control Message Protocol (ICMP), Internet Group Multicast Protocol (IGMP), Protocol Independent Multicast Sparse Mode (PIM-SM), Protocol Independent Multicast Dense Mode (PIM-DM), Internet Protocol Security (IPsec), Internet Packet Exchange (IPX), Routing Information Protocol (RIP), Datagram Delivery Protocol (DDP), and Border Gateway Protocol (BGP).

Returning to FIG. 2, transport layer 212 may provide general transport services such as connection-oriented data stream support, reliability control, flow control, congestion avoidance, and multiplexing services, while RFID application layer 210 provides the intended function of tag 110 or interrogator 120. RFID application layer 210, for example, may support both IPv4 and IPv6 network protocols. Transport layer 212 may support both User Datagram Protocol (UDP) and Transmission Control Protocol (TCP) transport protocols, or may utilize some other protocol such as, for example, AppleTalk Transaction Protocol (ATP), Cyclic UDP (CUDP), Datagram Congestion Control Protocol (DCCP), Fiber Channel Protocol (FCP), IL Protocol (IL), NetBIOS Framers Protocol (NBF), Stream Control Transmission Protocol (SCTP), Sequenced Packet Exchange (SPX), Structured Stream Transport (SST), UDP Lite, or Micro Transport Protocol (μTP).

Transport Layer 212, Network Layer 214, and MAC Layer 216 each receive a packet of data and provide a header layer to that packet. Consistent with some embodiments, RFID Application Layer 210 provides a packet consistent with an RFID Protocol such as the 18000-7:2009 protocol standard. Transport layer 212 inserts the RFID protocol packet into the payload of a transport layer protocol packet. Network layer 214 receives the transport layer protocol packet and places it into the payload of one or more network protocol packets for transmission by physical layer 218. Other features of protocol stack 200 are described in U.S. patent application Ser. No. 13/297,094, filed on Nov. 15, 2011, the contents of which is incorporated herein by reference in their entirety.

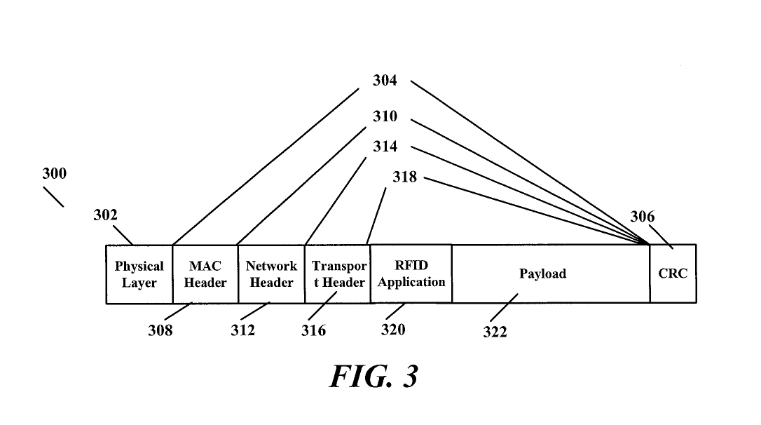

FIG. 3 illustrates a packet format for information transmitted by tags and interrogator, consistent with some embodiments. In particular, the packet format illustrated in FIG. 3 may correspond to a protocol stack such as that illustrated in FIG. 2. As shown in FIG. 3, a packet 300 includes a header 302, a payload 304, and error correction 306. Consistent with some embodiments, error correction 306 can be a cyclic redundancy check (CRC) or other error correction technique. Header 302 includes commands and routing information regarding the packet. Payload 304 includes the packet data. Moreover, in a layered protocol system, payload 304 can include headers and data from a higher protocol layer. Payload 304 further includes a MAC header 308 and a MAC payload 310 that are generated by MAC layer 216. MAC payload 310 may include a network header 312 and network payload 314 that was generated by network layer 214. Network payload 314 may include a transport header 316 and transport payload 318 generated by transport layer 212. Finally, transport payload 318 may include the RFID application header 320 and RFID application payload 322 generated by application layer 210. Each of these packets may be of varying lengths and the information contained in each of the headers is dependent upon the actual protocol being implemented. Consistent with some embodiments, transport layer 212 and network layer 214 may be absent from a protocol stack, resulting in the absence of transport header 316 and network header 312 from packets 300.

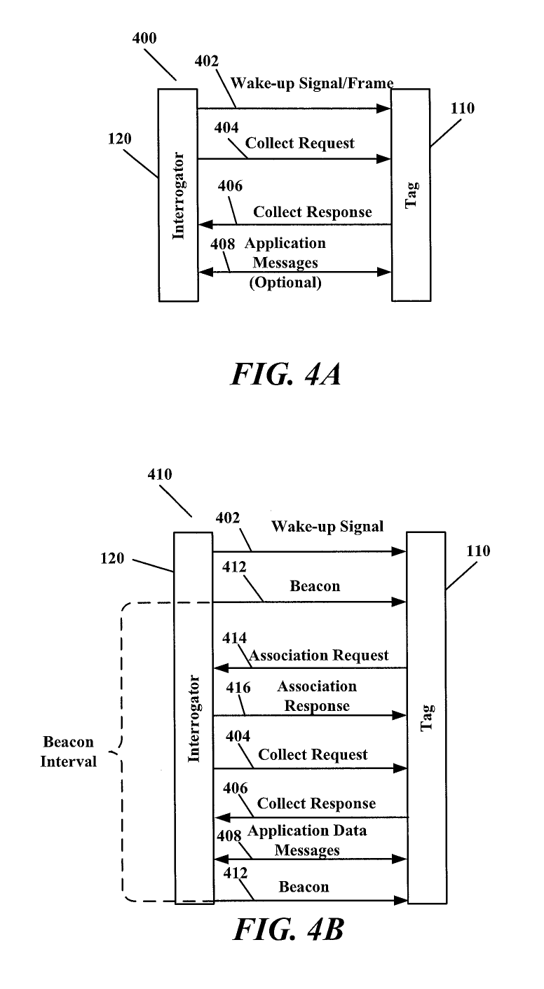

FIGS. 4A and 4B illustrate methods for polling a tag by an interrogator, consistent with some embodiments. FIG. 4A illustrates communications in a beaconless network, while FIG. 4B, illustrates communications in a network having a beacon. As shown in FIG. 4A, interrogator 120 the method 400 initially transmits a wake-up signal 402, which is received by tag 110. Consistent with some embodiments, interrogator 120 may also send a broadcast data frame including a Collect Request application command 404, to initialize a collection procedure. The Collect Request command is an application request message and it may contain, for example, the following parameters: Collect_request (access method (CSMA-CA|ALOHA), beacon enabled, association required, security required, Friendly interrogator authentication, Collection attributes, awake time, etc). Consistent with some embodiments, the attributes “beacon enabled,” “association required,” “security required,” and “friendly interrogator authentication” are flags and can have an On/Off value. These are MAC layer 216 configurable parameters and can be retrieved by the RFID application layer 210. That is, MAC layer 216 may expose a set of Application Programming Interfaces (APIs) so that the MAC layer configurable parameters may be retrieved by RFID application layer 210. If “Friendly interrogator authentication” flag is set to “On” then collection request command 404 may contain additional parameters, ensuring that tag 110 communicates with a known, or “friendly”, interrogator. A selected method for access to a network may be included in the Collect_request parameter. According to some embodiments, CSMA-CA or ALOHA may be supported methods for access the network.

After receiving the data frame with the Collect Request application command 404, tag 110 may transmit a data frame with a Collect Response message 406. Collect Response message 406 may include all data requested by Collect Request command 404 which may include a tag identity and status, depending on the type of collection request. Consistent with some embodiments, tag 110 can send the response using a method described in the Collect Request command 404. Further consistent with some embodiments, tag 110 may stay awake for a predetermined period of time, which can be configurable or transferred in Collect Request command 404. In this period interrogator 120 can send additional application data frames containing additional application requests 408, which are requests directed to RFID application layer 210 of tag 110, to which tag 110 can provide a response. Consistent with some embodiments, exchanged frames may contain application requests and responses embedded into MAC layer data frames only. Consistent with such embodiments, the application requests and responses are embedded into a frame just after MAC header 308. Once method 400 is complete, then tag 110 returns to a sleep mode, once again waking periodically to determine the presence of another wake-up signal 402. Consistent with some embodiments, communications 404, 406, and 408 between interrogator 120 and tag 110 may be terminated at RFID application layers 210 of both interrogator 120 and tag 110 so that RFID application layers 210 of both interrogator 120 and 110 can retrieve data from their respective MAC layers 216 using efficient MAC APIs.

Consistent with some embodiments, interrogator 120 may support both a “non-intelligent” wake-up signal and an “intelligent wake-up” signal. A non-intelligent wake-up signal does not carry information about the network besides indicating existence of the network. An example of a non-intelligent wake-up signal is the wake-up UHF tone described in ISO 18000-7:2009. Wake-up signal 402 may be implemented using: low frequency (LF), ultra-high frequency (UHF), or a special MAC/PHY frame. An intelligent wake-up signal may include the following parameters: a beacon interval, a beacon offset, association required, security required, or an active RF data channel number. The wake-up signal can be implemented as continuous or distributed.

Since FIG. 4A is directed to a beaconless network, interrogator 120 does not send a periodic beacon to advertise network capability. According to some embodiments, the beacon interval (BI) is a MAC-configurable parameter. For example, if BI=0, then the MAC is not providing instructions for sending a beacon signal and the network is in a beaconless mode of operation. In some embodiments, only interrogator 120 is capable of creating a network and having the BI as a configurable parameter. Consistent with some embodiments, interrogator 120 may collect information from a large number of tags 110 that are configured to move quickly past interrogator. In such embodiments, the tags may have short exposure to the network created by interrogator 120, and in order to facilitate data exchange, interrogator 120 may not require tags 110 to join the network in order to exchange information, such as data frames, including application layer data. However, consistent with such embodiments, interrogator 120 has first priority to collect the identification and status of tags 110 and, if possible, follow-up data from some tags 110.

FIG. 4B is a block diagram describing the data collection process 410 in a beacon-enabled wireless tag network, consistent with some embodiments. Similar to FIG. 4A, interrogator 120 may support either a non-intelligent wake-up signal or an intelligent wake-up signal. Moreover, interrogator 120 may send a periodic beacon signal 412 to advertise network capability. In this case, if the BI parameter is BI≠0, then the MAC is providing instructions for periodically sending beacon signal 412. Consistent with some embodiments, interrogator 120 may require tags 110 to join the network in order to communicate with interrogator 120.

As shown in FIG. 4B, interrogator 120 first transmits a wake-up signal 402 that is received by tag 110. Interrogator 120 then transmits beacon signal 412 advertising that interrogator 120 has network capabilities. If interrogator 120 requires tag 110 to join the network in order to communicate with interrogator 120, tag 110 will then transmit an association request message 414 to interrogator 414. In response, interrogator 120 will transmit an association response message 416. If tag 110 is permitted to join the network provided by interrogator 120, interrogator will then transmit a Collect Request command 404, receive a Collect Response message 406, and transmit optional application data messages 408, similar to method 400 illustrated in FIG. 4A. Then, at the end of the beacon interval, interrogator 120 will again send beacon signal 412 advertising the network capabilities of interrogator 120.

Consistent with some embodiments, interrogator 120 may create and store a tag device table in memory 128. A tag device table may, for each tag polled by interrogator 110, include values for the following tag information: tag device MAC address, tag device identification (ID), tag device association ID, tag device group ID, tag device security parameters, a number of beacon intervals, and any additional elements that need to be defined and stored in memory 128. This tag information may be requested in the collection request command 404 or the application data message 408, and may be supplied by tag 110 in collect response message 406. Each device, tag and interrogator both, that is supported with this type of wireless network has a unique MAC address. In addition, tag devices may have a tag device ID that may be configured during a commissioning procedure or may be assigned by an application. The tag device association ID may be assigned by an interrogator when a tag joins the network. A tag device group ID may refer to a collection of tag devices that are grouped together during a collection process, and will be communicated to each tag device upon assignment. Consistent with some embodiments, tags can be grouped by application relevant criteria such as sensor tags. A collect application can also decide to further collect just certain groups of tags and not the complete population of the tags, enabling subsequent selective collection procedures. Moreover, a collection application can perform a selective collection of already associated tags belonging to a certain group. For example, sensor tags collected by the same interrogator may have assigned the same group ID. The interrogator may then issue Collect Request commands with the group ID to collect just the members of this group. Tag device security parameters may contain pre-shared keys, a key index, mutual authentication methods, methods used for encryption and/or authentication of the data frames, and may be implemented as a separate table. The number of beacon intervals (N) is assigned to each tag device during the association process, and the tag devices will multiply this number with the beacon interval (BI) and wake up periodically every N times BI. Thus, some tags can wake up every beacon interval if N=1, or every N beacon intervals if N>1.

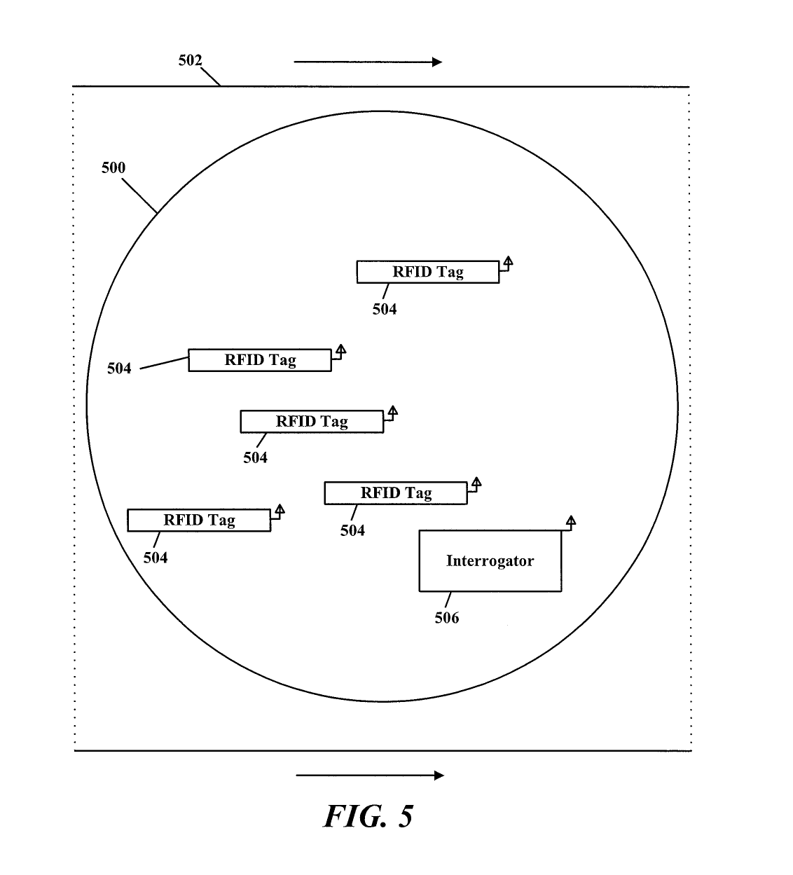

FIG. 5 is a diagram illustrating a wireless tag network 500 on a moving platform 502, consistent with some embodiments. As shown in FIG. 5, a plurality of tags 504 may be rapidly moving on platform 502 and be part of a wireless network 500 with hybrid interrogator 506 also installed on platform 502. Consistent with some embodiments, hybrid interrogator may be stationary on platform 502, or also may be moving on platform 502. Consistent with some embodiments, tags 504 may be the same or similar to tags 110 and hybrid interrogator 506 may be the same as interrogator 120. The communication methods for polling tags shown in FIG. 4A can be efficient when used in a method to poll tags 504 moving by hybrid interrogator 506, but as the population of tags 504 becomes larger and the speed of the moving tags 504 increases, physical limits of network 500, such as the bit rate, may be a limiting factor and, as a result, the network may become sluggish and unresponsive. This is especially the case when a low speed MAC (i.e., a MAC layer that communicates at a low bit rate, such as 28 kb/s) is used, as in some networks. In order to improve the operation of network 500, hybrid interrogator 506 may be configured to be a hybrid tag/interrogator such that hybrid interrogator 506 acts as an interrogator in network 500, but acts as a tag in another network. By using such hybrid interrogators, a hierarchy of networks can be created to ensure the proper polling, communication and data collection of all tags. Moreover, a combination of the methods of FIGS. 4A and 4B may be used to poll the tags and ensure that all tags are accurately accounted for.

Consistent with some embodiments, tag devices 504 may be associated with hybrid interrogator 506 through association requests 414 and association responses 416 performed in accordance with FIG. 4B. Moreover, tags 504 configured to be solely associated to a single interrogator such that tags 504 may be unresponsive if interrogated by any other interrogator, unless released by hybrid interrogator 506. Consistent with the methods shown in FIGS. 4A and 4B, hybrid interrogator 506 performs a periodic collection of tags 504 and, among other things, may record alarms received from tags 504 and other information as discussed above that may be stored in a table in memory 128.

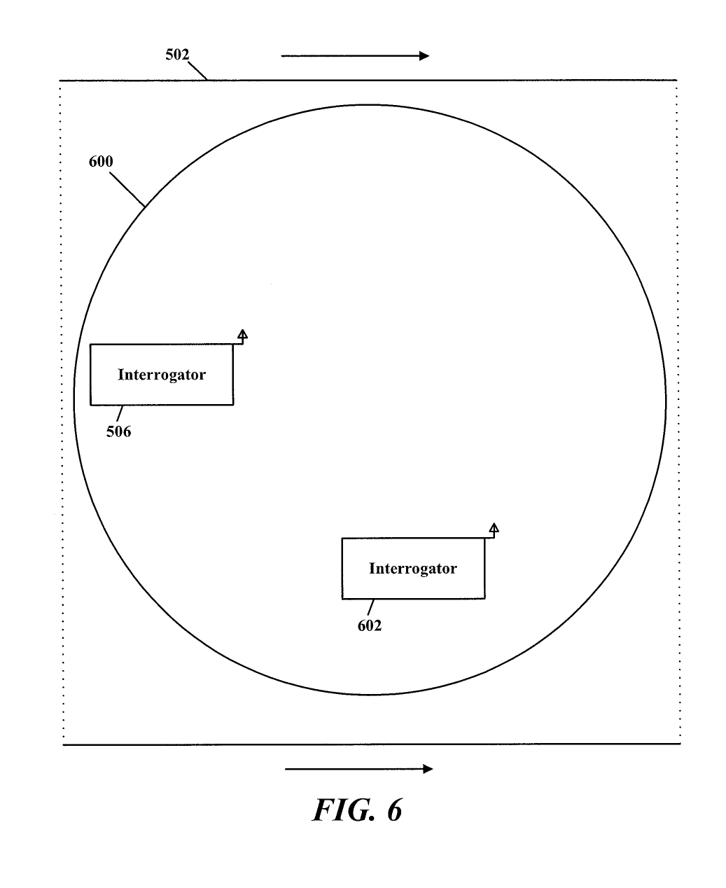

FIG. 6 illustrates a wireless tag network in a higher hierarchical level, consistent with some embodiments. As shown in FIG. 6, interrogator 602 may be fixed in a chokepoint of wireless network 600 along moving platform 502, however, interrogator may also be moving along platform 502 according to some embodiments. Interrogator 602 may create wireless network 600 and, in wireless network 600, hybrid interrogator 506 may perform a tag function. Consistent with some embodiments, wireless network may be beaconless or be beacon-enabled. Further consistent with some embodiments, hybrid interrogator 506 may join network 600 if requested by interrogator 602, and interrogator 602 may collect information from hybrid interrogator 506. Hybrid interrogator 506 may include information collected from all tags 504 in network 500, including received alarms, if any, and is able to report this information to interrogator 602. Moreover, interrogator 602 can communicate information and commands to tags 504 in wireless network 500 through hybrid interrogator 506. These commands and information may be transmitted to tags 504 at appropriate time intervals to avoid collisions and retransmissions.

As shown in FIGS. 5 and 6, by creating hierarchical networks 500 and 600, data collection for tags 504 may be made more efficient than by attempting to collect data from all tags in network 500 using only hybrid interrogator 506. This is because during the collection process in the network 600 only one hybrid interrogator (506) competes for the access to the interrogator 602 minimizing the number of collisions and retransmissions. Consistent with some embodiments, wireless networks 500 and 600 may be ISO 18000-7:2009 networks, with ISO18000-7:2009 interrogators and tags. However, in other embodiments, other wireless technologies and protocols can be used, such as IEEE 802.15.4.

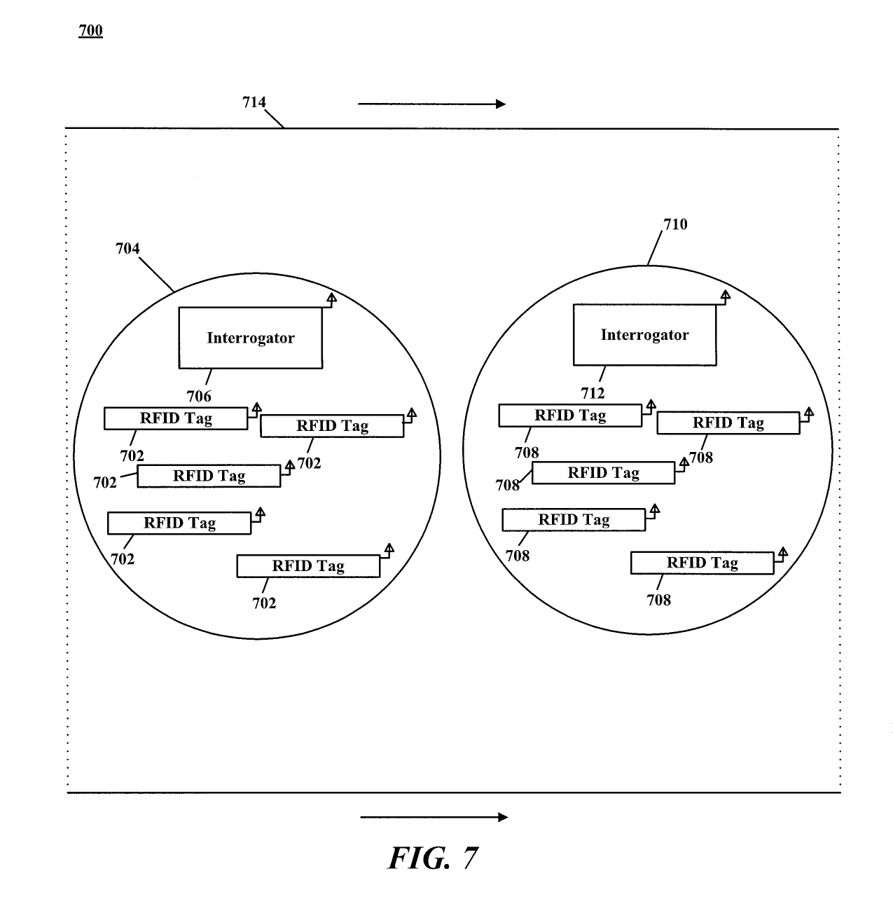

Although FIGS. 5 and 6 illustrate using two wireless network hierarchy levels to increase efficiency, FIGS. 7-9 illustrate a system that uses more than one network in a hierarchy level. FIG. 7 illustrates a system having multiple wireless networks in a hierarchical level, consistent with some embodiments. As shown in FIG. 7, the system 700 includes multiple tags 702 as part of a first wireless network 704 created by first hybrid interrogator 706 and multiple tags 708 as part of a second wireless network 710 created by second hybrid interrogator 712. Tags 702 and 708 and hybrid interrogators 706 and 712 are all on moving platform 714. According to some embodiments, hybrid interrogators 706 or 712 may be stationary or moving on moving platform 714. Consistent with some embodiments, interrogator 706 may poll and collect data and information from tags 702 in network 704 and interrogator 712 may poll and gather data and information from tags 708 in network 710. The polling of tags 702 and 708 and collection of data therefrom may be performed by interrogators 706 and 712 consistent with the methods described in FIGS. 4A and 4B. Consistent with some embodiments, networks 704 and 710 may be beaconless networks or beacon-enabled networks.

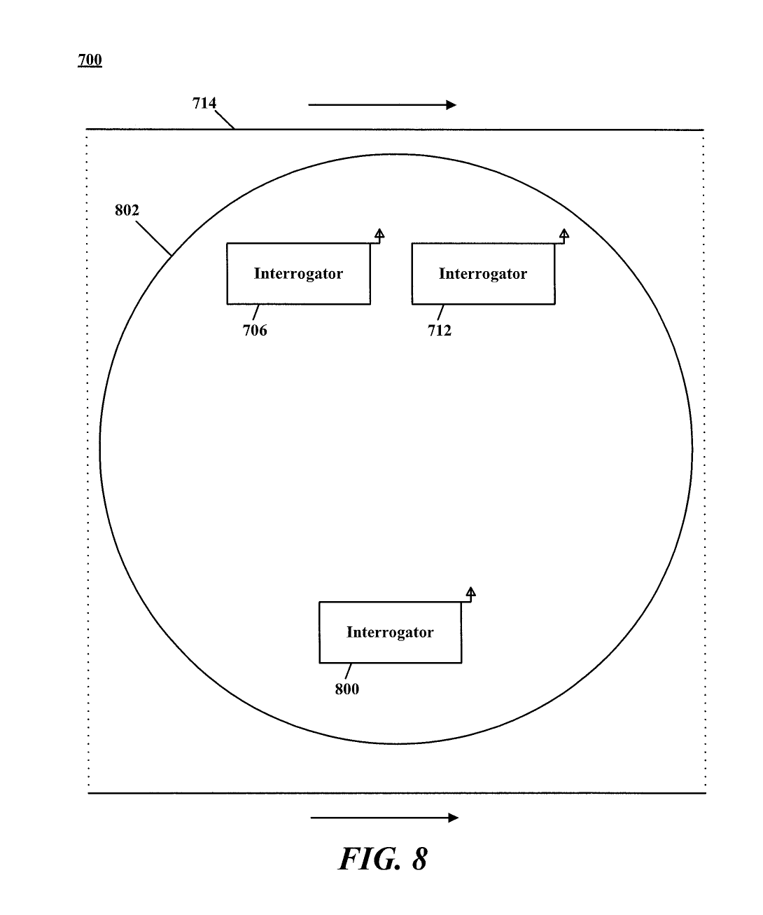

FIG. 8 is a diagram illustrating a higher hierarchical level in system 700, consistent with some embodiments. As shown in FIG. 8, hybrid interrogator 800 creates a wireless network 802 and polls and collects data from hybrid interrogators 706 and 712 which act as tags in this hierarchy level. Consistent with some embodiments, network 802 may be beaconless or beacon enabled. Moreover, hybrid interrogator 800 may be configured to move along moving platform 714 such that numerous hybrid interrogators, in addition to hybrid interrogators 706 and 712, are polled for information collection. Similar to FIG. 6, hybrid interrogators 706 and 712 may respectively include information collected from tags 702 in network 704 and tags 708 in network 710, including received alarms, if any, and to report this information to hybrid interrogator 800. Moreover, hybrid interrogator 800 can communicate information and commands to tags 702 in wireless network 704 through hybrid interrogator 706 and to tags 708 in network 710 through hybrid interrogator 712. These commands and information may be transmitted to the tags at appropriate time intervals to avoid collisions and retransmissions.

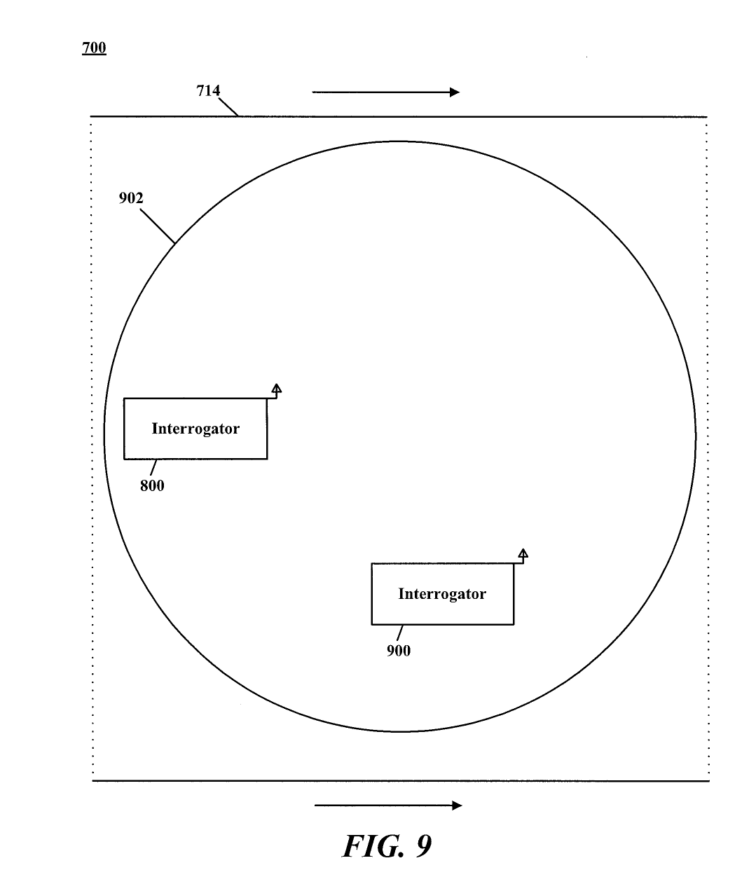

FIG. 9 is a diagram illustrating a higher hierarchical level in system 700, consistent with some embodiments. As shown in FIG. 9, interrogator 900 creates a wireless network 902 and polls hybrid interrogator 800 for information collection. In this hierarchical level, hybrid interrogator 800 acts as a tag. Consistent with some embodiments, interrogator 900 may be moving along moving platform 714, or may be fixed at a choke point on moving platform 714. Further consistent with some embodiments, network 902 may be beaconless or beacon enabled. As described above, hybrid interrogator 800 may include information collected from hybrid interrogators 706 and 712 which may further include information collected from tags 702 in network 704 and tags 708 in network 710, including received alarms, if any. This information can be reported to interrogator 900. Moreover, interrogator 900 can communicate information and commands to tags 702 and 708 and hybrid interrogators 706 and 712 through hybrid interrogator 800. Alternatively, hybrid interrogators 706 and 712 may communicate directly with interrogator 900 through network 902, bypassing the hierarchical level of system 700 shown in FIG. 8.

Consistent with some embodiments, interrogator 900 may be a hybrid interrogator and may be used as a tag such that an interrogator in a higher hierarchical level can poll interrogator 900 for information collection and receive information about interrogator 900 and all hybrid interrogators and tags in the lower hierarchical levels. This can be repeated to include higher hierarchical levels by using additional hybrid interrogators. Consequently, a system could be implemented which uses any number of hierarchical levels.

Embodiments described herein provide systems and methods that utilize hybrid interrogators that can act as both an interrogator and a tag to create hierarchical levels of data collection and transmission. By creating hierarchical levels of data collection and transmission, many tags moving through a polling area can polled for data collection and reported with minimal data loss, collisions, and retransmissions. Consequently, the systems and methods provided herein may provide a system for tag data collection that is more efficient than prior art methods. Further the systems and methods provided herein are scalable to ensure that any amount of tags can be accurately polled for data collection and reported. The embodiments described above are exemplary only. One skilled in the art may recognize various alternative embodiments from those specifically disclosed. Those alternative embodiments are also intended to be within the scope of this disclosure. As such, the disclosure is limited only by the following claims.

What is claimed is:

1. A system for collecting information from one or more radiofrequency identification (RFID) tags, comprising:
the one or more RFID tags;
a first interrogator device, the first interrogator device configured to:
perform interrogator functions in a first wireless network, the interrogator functions including creating the first wireless network, transmitting a wake-up signal and a collection request command to the one or more RFID tags; and
perform tag functions in a second wireless network, the tag functions including responding to a wake-up signal and transmitting a collect response message in response to a received collection request command; and
a second interrogator device, the second interrogator device configured to perform interrogator functions in the second wireless network, the interrogator functions including creating the second wireless network, transmitting a wake-up signal and a collection request command to the first interrogator when the first interrogator is in the second wireless network.

2. The system of claim 1, wherein the one or more RFID tags are on a moving platform.

3. The system of claim 1, wherein the first wireless network is a beacon-enabled network.

4. The system of claim 3, wherein the first interrogator device is further configured to:
periodically transmit a beacon signal; and
transmit an association response message to a received association request message received from the one or more RFID tags.

5. The system of claim 1, wherein the first interrogator device comprises a first media access control (MAC) address and a second MAC address.

6. The system of claim 1, wherein the second interrogator device is further configured to:
perform tag functions in a third wireless network, the tag functions including responding to a wake-up signal and transmitting a collect response message in response to a received collection request command.

7. The system of claim 6, further comprising:
a third interrogator device, the third interrogator device configured to perform interrogator functions in the third wireless network, the interrogator functions including creating the third wireless network, transmitting a wake-up signal and a collection request command to the second interrogator when the second interrogator is in the third wireless network.

8. The system of claim 1, wherein:
the collection request command to the one or more RFID tags requests one or more parameters from the one or more RFID tags, the one or more parameters including a tag device MAC address, a tag device identification (ID), a tag device association ID, a tag device group ID, and tag device security parameters; and
the one or more RFID tags provides the requested one or more parameters in response to the collection request command to the one or more RFID tags.

9. The system of claim 8, wherein the first interrogator device provides the one or more parameters to the second interrogator device in the collect response message.

10. The system of claim 2, wherein the first interrogator device is on the moving platform, and the second interrogator device is stationary.

11. The system of claim 1, wherein the first wireless network and the second wireless network conform to the International Standards Organization (ISO) 18000-7:2009 protocol.

12. The system of claim 1, wherein the first wireless network and the second wireless network conform to the Institute of Electrical and Electronic Engineers (IEEE) 802.15.4 protocol.

13. The system of claim 1, wherein the transmitted wake-up signal comprises an intelligent wake-up signal.

14. A method for collecting information from one or more radiofrequency identification (RFID) tags by an interrogator, comprising:
transmitting, by the interrogator, a wake-up signal;
transmitting, by the interrogator, a collect request command;
receiving, by the interrogator, a collect response message; and
transmitting and receiving, by the interrogator, additional application requests.

15. The method of claim 14, wherein the wake-up signal comprises an intelligent wake-up signal.

16. The method of claim 14, further comprising:
periodically transmitting, by the interrogator, a beacon signal advertising network capabilities of the interrogator; and
transmitting, by the interrogator, an association response message in response to an association request message received from the one or more RFID tags.

17. The method of claim 14, wherein the collect request command comprises a plurality of parameters, the plurality of parameters being media access control (MAC) layer-configurable parameters that are accessible by an RFID application layer of the one or more RFID tags.

18. A hybrid interrogator device, comprising:
a power source;
a processor;
a memory coupled to the processor;
a clock generator coupled to the processor;
a beacon signal generator coupled to the processor; and
a transceiver coupled to the processor,
wherein the memory includes instructions that, when executed by the processor cause the hybrid interrogator device to perform interrogator functions in a first wireless network and perform tag functions in a second wireless network.

19. The hybrid interrogator of claim 18, wherein the tag functions include responding to a wake-up signal and transmitting a collect response message in response to a received collection request command

20. The hybrid interrogator of claim 18, wherein the interrogator functions include creating the first wireless network, and transmitting a wake-up signal and a collection request command.

21. A system for collecting information from one or more radiofrequency identification (RFID) tags, comprising:
the one or more RFID tags; and
one or more of the hybrid interrogators of claim 18, wherein
the one or more hybrid interrogators create a hierarchical information collection network such that a first level of hybrid interrogators collects information from the one or more RFID tags, a second level of hybrid interrogators collects information from the first level of hybrid interrogators, including the collected information from the one or more hybrid interrogators, and each successive level of hybrid interrogators collects information from a previous level of hybrid interrogators.
